(19) United States
(12) Patent Application Publication
(10) Pub. No.: US 2005/0045048 A1
(43) Pub. Date: Mar. 3, 2005

(54) Electric food slicer

(75) Inventors: Wing Chung Joseph Lau, Pokfulam (HK); Leung Chi Ho, New Territories (HK)

Correspondence Address: BURNS DOANE SWECKER & MATHIS L L P, POST OFFICE BOX 1404, ALEXANDRIA, VA, 22313-1404, US

(73) Assignee: Eastern Sources Housewares (Hong Kong) Limited, Kowloon (HK)

(21) Appl. No.: 10/648,332

(22) Filed: Aug. 27, 2003

(51) Int. Cl. B02C 25/00

(52) U.S. Cl. 99/492

(57) ABSTRACT

An electric food slicer disposable in at least a storable configuration and an operable configuration, comprising a base portion movably connected to an operating portion, wherein the slicer excluding its cutting blade for processing foodstuffs is made principally of plastics or polymeric materials of relatively light weight, and wherein the slicer further comprises a locking means adapted to secure the relative position of the two portions in either said operable configuration or said storable configuration.

### FIELD OF INVENTION

This invention relates to an electric food slicer and in particular a foldable electric food slicer made principally of plastics or polymeric materials.

### BACKGROUND OF THE INVENTION

There are a variety of electric food slicers for slicing foodstuffs. Since conventional electric food slicers are more commonly used by restaurants or food suppliers for commercial food processing, these food slicers are normally relatively bulky in size and are for heavy-duty use. They are usually made principally of metallic substances so they are relatively sturdy.

Recently, however, smaller electric food slicers have become popular and are available for use in, for example, households. For reason of storage, some of these smaller food slicers are made to be foldable so that when they are not in use they may be folded and stored in a cabinet. For cost reason, some of these smaller food slicers are made principally of plastics materials. However, these smaller food slicers are less reliable in slicing foodstuffs and may thus be dangerous in operation.

It is thus an object of the present invention to provide an electric food slicer in which the above shortcomings are mitigated, or at least to provide a useful alternative to the public.

### SUMMARY OF INVENTION

According to a first aspect of the present invention, there is provided an electric food slicer disposable in at least a storable configuration and an operable configuration, comprising a base portion movably connected to an operating portion, wherein the slicer excluding its cutting blade for processing foodstuffs is made principally of plastics or polymeric materials of relatively light weight, and wherein the slicer further comprises a locking means adapted to secure the relative position of the base portion and said operating portion in either the operable configuration or the storable configuration. Preferably, the operating portion may comprise the cutting blade. In the operable configuration, the slicer may be used to slice foodstuffs.

In a preferred embodiment, the locking means comprises at least one bolt movable between two positions adapted to secure the relative position of the base portion and the operating portion, or maintain the storage configuration of the slicer. In particular, the bolt may be adapted to be received in a recess of an engaging means, and when the bolt is received in the recess the relative position of the base portion and the operating portion is secured. In a preferred embodiment, the bolt is connected to a switch operable by a user for adjusting the position of the bolt. Alternatively, other suitable locking means such as one comprising a latch and a matching strike plate may be used.

In a preferred embodiment, the bolt may be comprised in the base portion. In another embodiment, the bolt may be comprised in the operating portion of the slicer. In the former embodiment, the engaging means defining the recess may be comprised in the operating portion, and the bolt may be receivable by the recess. In the latter embodiment, the engaging means is comprised in the base portion, and the bolt is receivable by the recess.

Preferably, the food slicer may further comprise a handle. The handle may be provided at an upper end of the slicer for easy transportation thereof. In particular, the handle may be in the form of a strap connected to the upper end of the slicer.

Suitably, the base portion and the operating portion are pivotably connected together. However, other suitable connecting means may be used for connecting the portions together. For example, the portions may be hingedly connected together.

The plastics materials may be selected from a group comprising acrylonitrile butadiene styrene (ABS), polypropylene (PP) and polycarbonate (PC).

### BRIEF DESCRIPTION OF THE DRAWINGS

An embodiment of the present invention will now be described, by way of example only, with reference to the following drawings in which:

FIG. 1 is a top view showing an embodiment of a food slicer according to the present invention;

FIG. 2 is a bottom view of the food slicer shown in FIG. 1;

FIG. 3 is a cross section view of the food slicer taken along A-A of FIG. 2;

FIG. 4 is a front view of the food slicer shown in FIG. 1;

FIG. 5 is a cross section view of the food slicer taken along B-B of FIG. 4;

FIG. 6 is a side view of the food slicer shown in FIG. 1;

FIG. 7 is another side view of the food slicer shown in FIG. 1;

FIG. 8 is a front perspective view of the food slicer shown in FIG. 1 in an operable configuration;

FIG. 9 is a perspective view of the food slicer shown in FIG. 1 but in a folded or non-operable configuration; and

FIGS. 10 to 13 are successive perspective views of the food slicer shown in FIG. 9 being unfolded to it operable configuration.

### DETAILED DESCRIPTION OF PREFERRED EMBODIMENTS

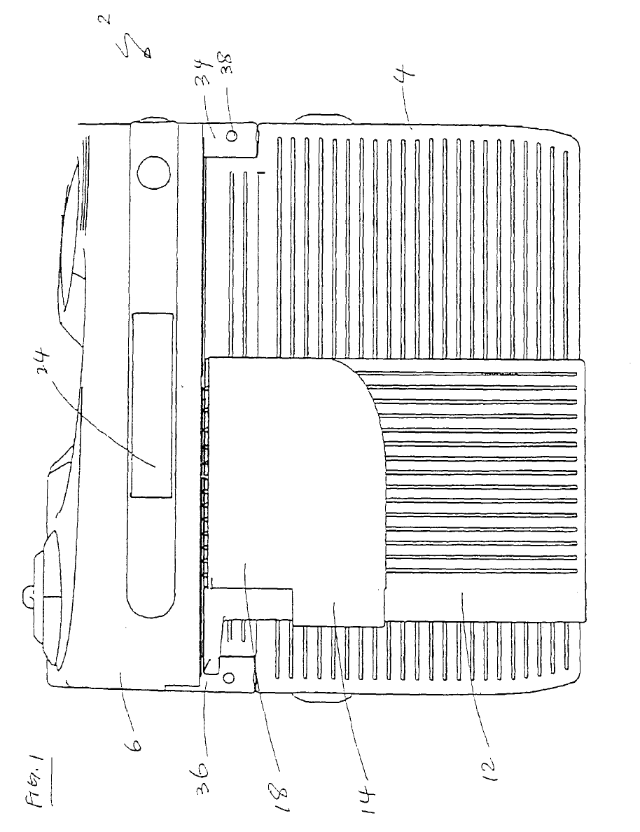

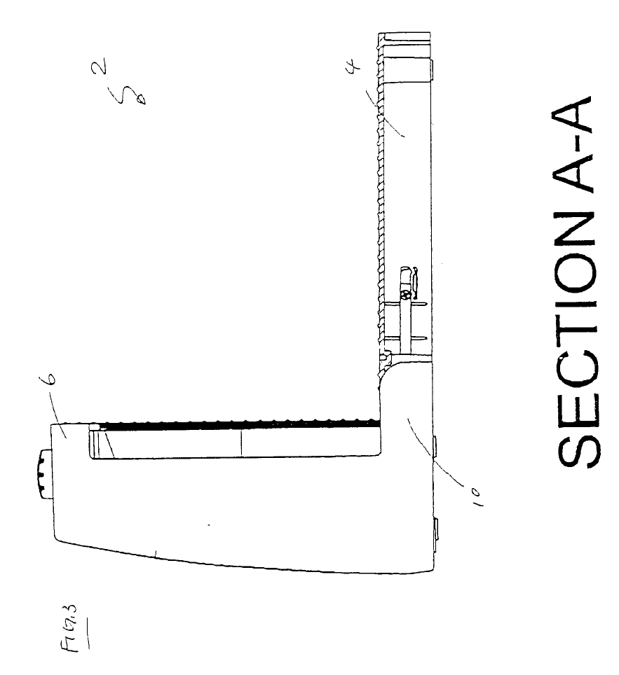

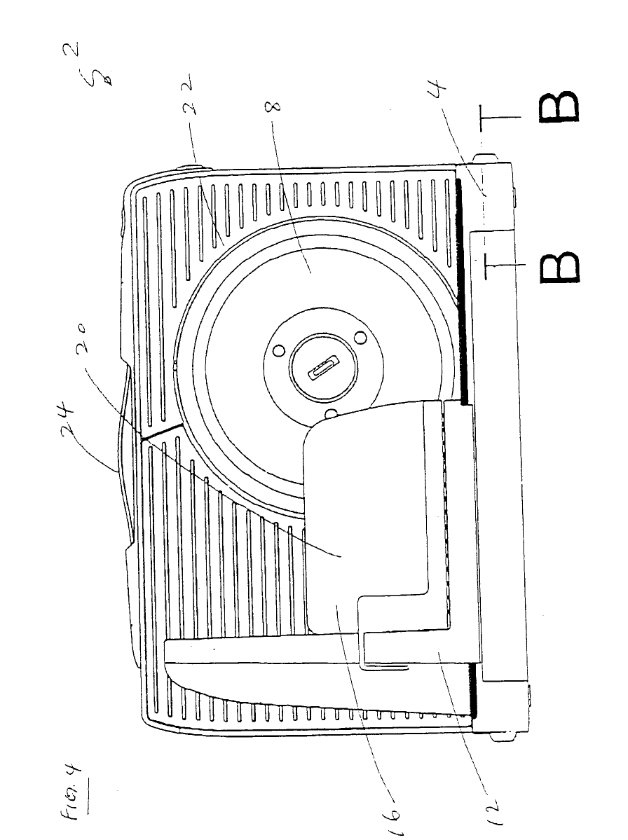

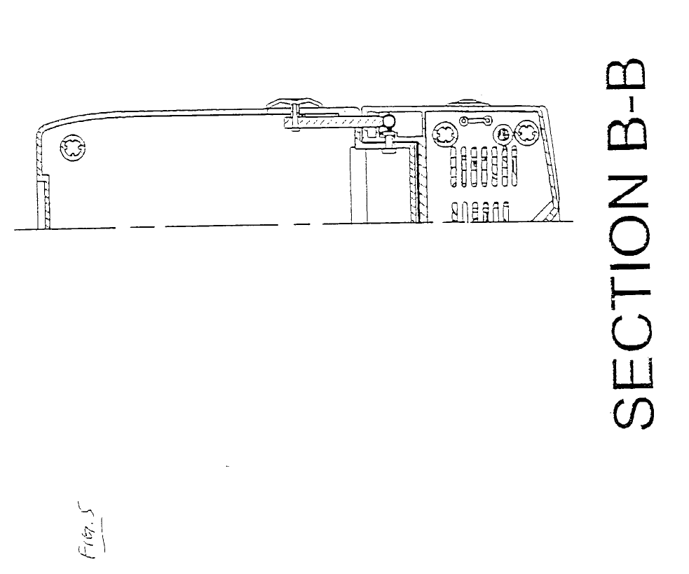

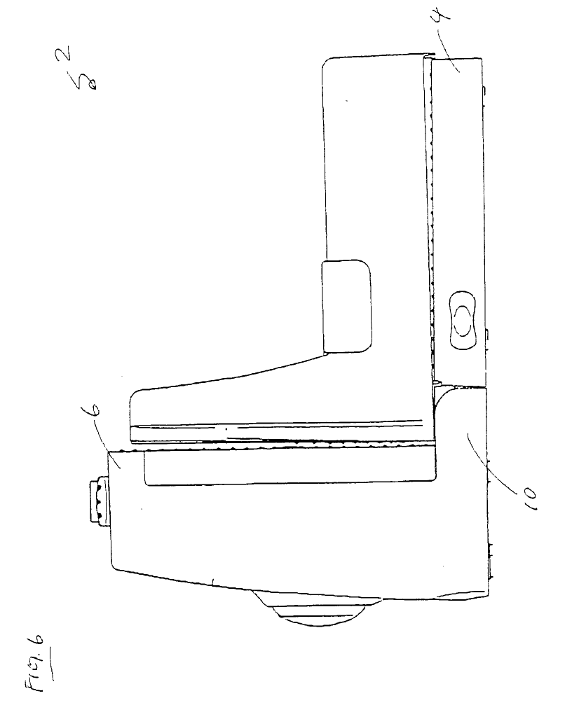

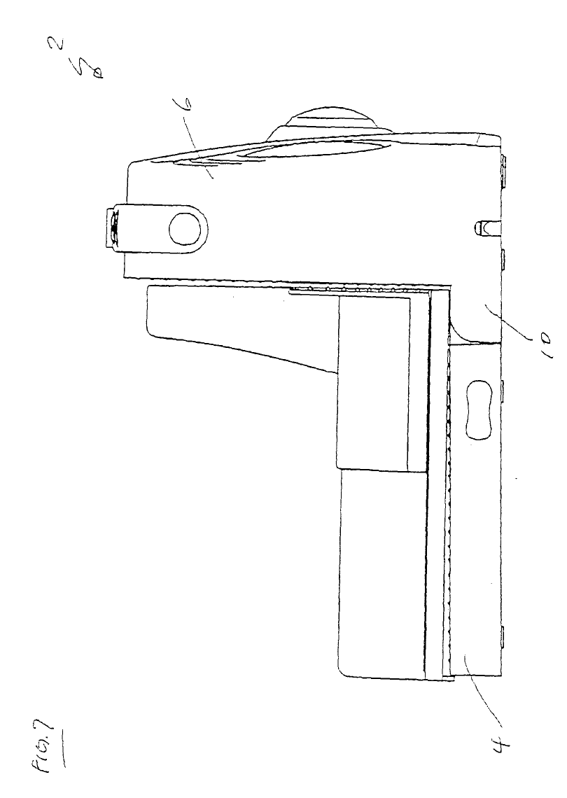

An embodiment of an electric food slicer according to the present invention is shown in FIGS. 1 to 13, and generally designated as 2. Referring firstly to FIGS. 1 to 7, the slicer 2 is a stand alone unit of a conveniently small size which can be placed on a work surface in a kitchen in a household or at some other location in the home as desired. Alternatively, it can also be used in the meat section of a supermarket or grocery store.

The slicer 2 comprises a base 4 in the form of a generally horizontal platform and an operating portion in the form of a generally upstanding main body 6 to which a cutting means in the form of disc-like rotary blade 8 is attached. A lower end 10 of the main body 6 is hingedly connected to the base 4. A stage 12 is removably connected to the base 4. A movable food feeder in the form of a carriage 14 fitted with a food presser 16 slidably sits on top of the stage 12 and includes a planar plate 18 and an end wall 20 which upstands perpendicular upward at one end of the plate 18. A vertical wall 22 is arranged adjacent to and extending from the main body 6 and is connected at its lower end to the stage 12, with the blade 18 being exposed over a region adjacent the wall 22. The vertical wall 22 is approximately co-planar with the blade 8. For clarity purpose, an electric power cord connecting to the slicer 2 is not shown. A handle in the form of a strap 24 is connected to an upper end of the main body 6.

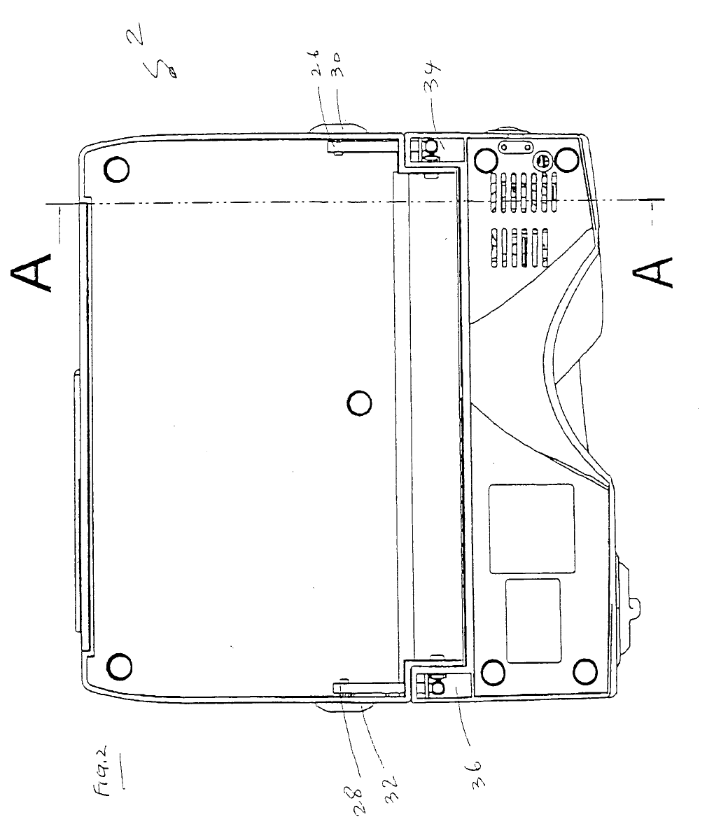

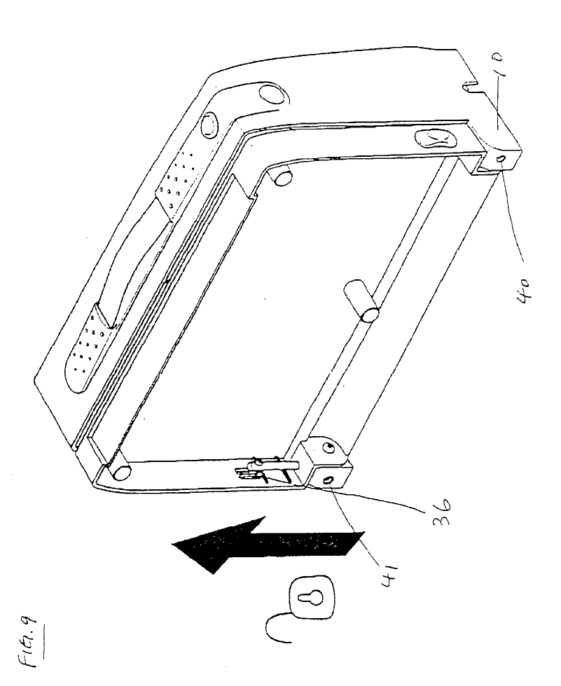

The slicer 2 comprises a locking mechanism. The locking mechanism includes a pair of movable bolts 26, 28 arranged on opposite sides of the base (see FIG. 2). The bolts 26, 28 are connected to a pair of switches (or actuators) 30, 32 for controlling the movement of the bolts 26, 28. The locking mechanism further includes a pair of engaging means 34, 36 at lower opposite ends of the main body 6. Each of the engaging means 34, 36 has two recesses (38, 40, 39, 41) for receiving the bolts (see FIGS. 9 to 12). The bolts 26, 28 are sized and shaped such that their ends can abut the engaging means 34, 36 and tightly fit into the recesses thereof. The bolts 26, 28 are movable between a position in which they do not abut with the engaging means and another position in which the bolts 26, 28 abut the engaging means and are received in one of the recesses thereof. In the former position, the base 4 is not locked to the main body 6 by the bolts and is freely pivotably movable relative to the main body 6. In the latter position, the base 4 is locked to the main body 6 such that the slicer 2 is either in a folded (storable) configuration or an unfolded (or operable) configuration. In the folded configuration, the carriage 14, the food presser 16, and the stage 12 are disassembled from the base 4 of the slicer 2.

It is to be noted that the slicer 2 is made of principally acrylonitrile butadiene styrene (ABS). However, any other suitable plastics materials (preferably of relatively light weight), such as polypropylene (PP) or polycarbonate (PC) may also be used.

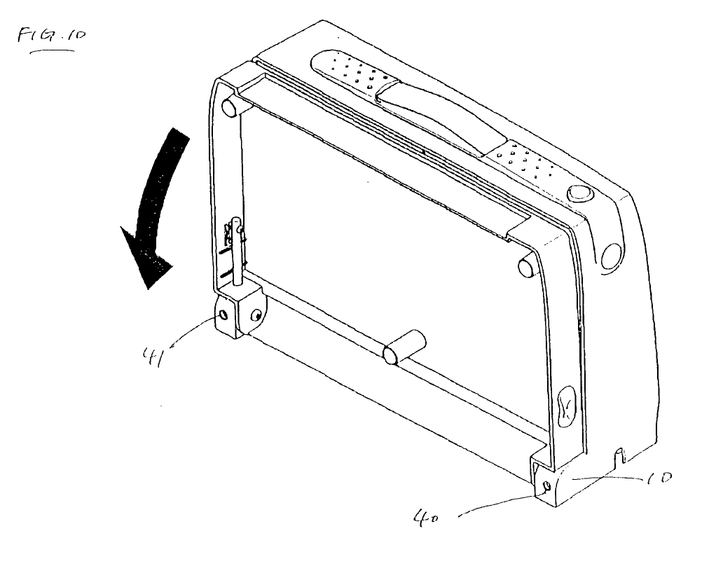

FIGS. 9 to 13 illustrate how the slicer 2 can be unlocked and then unfolded to the operable configuration. Firstly, referring to FIG. 9, the base 4 has been folded against the main body 6. In this configuration, the slicer 2 is more compact in size and is thus suitable for storage. To ensure that the base 4 is safely secured with the main body 6 and thus would not fall away from the main body 4, the switches 30, 32 connecting to the bolts 26, 28 are moved to abut the engaging means 34, 36 such that they are received in the recesses 38, 39. On the other hand, the switches 30, 32 are slid upward to disengage the bolts 26, 28 from the engaging means 34, 36 when the slicer 2 is to be unfolded to its operable configuration as shown in FIG. 10.

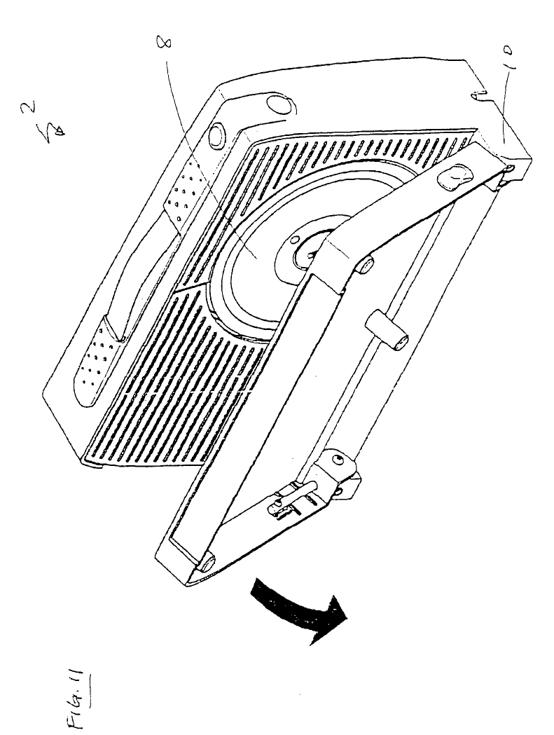

FIG. 11 shows that the slicer 2 is being unfolded. The bolts 26, 28 are not received by the recesses 38, 40 while the slicer 2 is being unfolded.

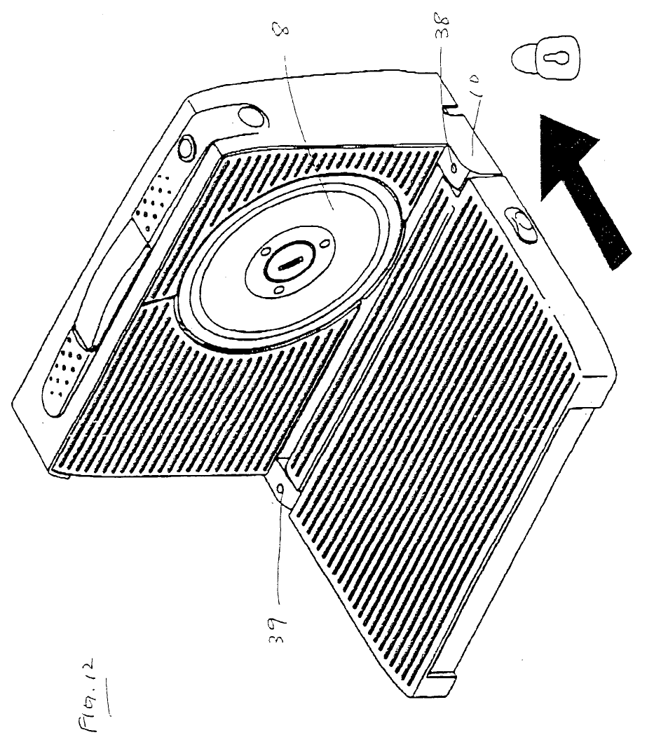

FIG. 12 shows that the base 4 after having been unfolded is locked into position by sliding the switches 30, 32 towards the lower end 10 of the main body 6 and thus engaging the bolts 26, 28 connecting thereto to the side recesses 40, 41 of the engaging means 34, 36.

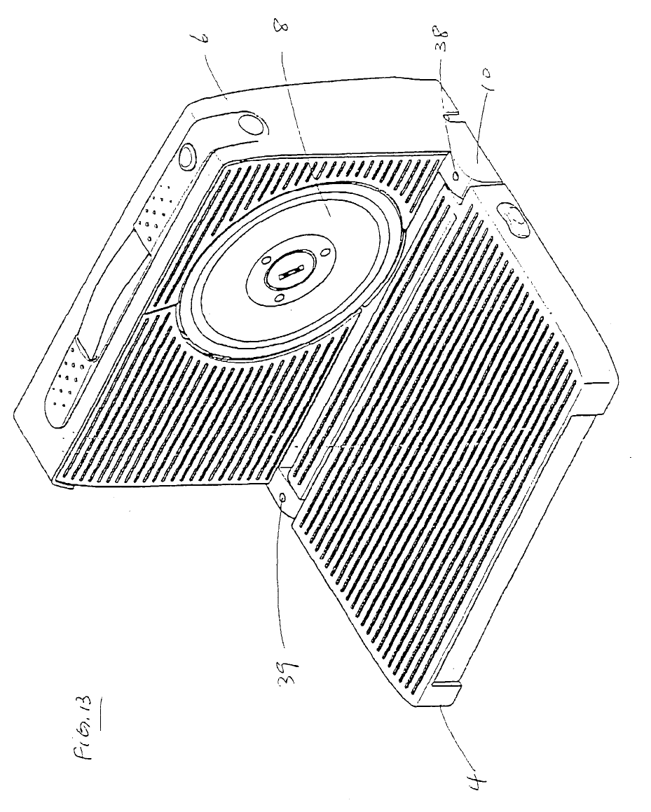

FIG. 13 shows that the base 4 has been locked in position and the slicer 2 has been unfolded and secured to its operable configuration.

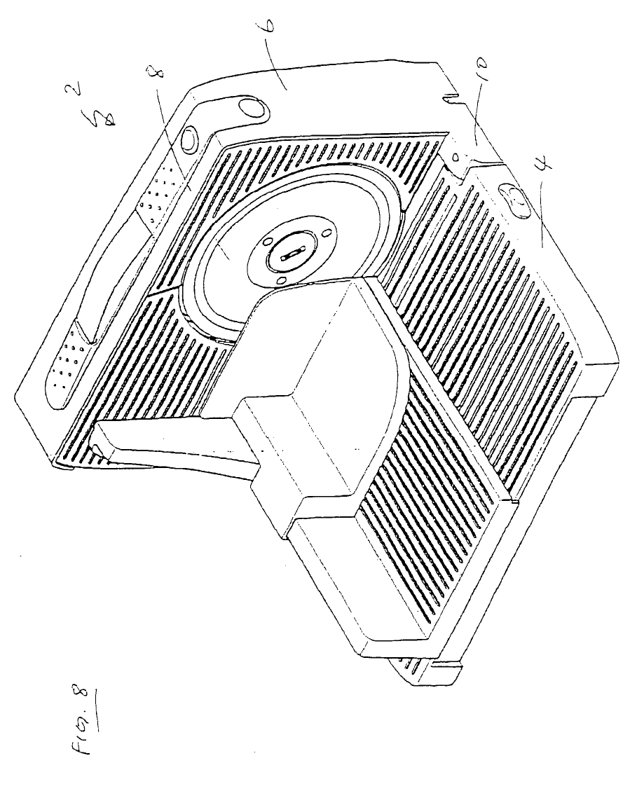

FIG. 8 shows that the stage 12, the carriage 14 and the food presser 16 have been assembled to the slicer 2.

It will be appreciated that when designing conventional commercial food slicers of relatively bulky in size and for heavy-duty use, it may not required to design them in such a way that they be foldable for storage. In such slicers the base and the main body are fixed in a certain position and no latches are required to secure them whether they are in use or not.

However, in smaller conventional electric household food slicers which are relatively compact in size whether when they are in use or not, they are often foldable such that the base thereof may be folded up against the main body. For this kind of food slicers, production cost is very critical, and as a result the materials used in making these slicers cannot be primarily of metallic materials since these materials are necessarily more expensive. One common material which is usually less expensive or of lower specification is a plastics or polymeric material, which, is almost always much lighter in weight. The drawback is that in use when the cutting blade of such a slicer is moving in high speed the slicer including the main body and the base often rattles vigorously and cutting foodstuffs with the slicer would become unreliable especially if a precise thickness of slices of foodstuffs is desired. More seriously, in extreme cases, the main body of the slicer would even topple over while in use and this is very dangerous because a user could be very seriously injured by the cutting blade moving in high speed.

With a slicer made in accordance with the present invention, the slicer is reliable and safe in cutting foodstuffs and yet the advantages resulting from its material of lower specification (and thus lower material cost) and foldable function are preserved.

1. An electric food slicer disposable in at least a storable configuration and an operable configuration, comprising a base portion movably connected to an operating portion, wherein said slicer excluding its cutting blade for processing foodstuffs is made principally of plastics or polymeric materials of relatively light weight, and wherein said slicer further comprises a locking means adapted to secure the relative position of said base portion and said operating portion in either said operable configuration or said storable configuration.

2. An electric food slicer as claimed in claim 1 wherein said operating portion comprises said cutting blade.

3. An electric food slicer as claimed in claim 1 wherein said locking means comprises at least one bolt movable between two positions adapted to secure the relative position of said base portion and said operating portion, or maintain said storage configuration of said slicer.

4. An electric food slicer as claimed in claim 3 wherein said bolt is adapted to be received in a recess of an engaging means, and when said bolt is received in said recess the relative position of said base portion and said operating portion is secured.

5. An electric food slicer as claimed in claim 3 wherein said bolt is connected to a switch operable by a user for adjusting the position of said bolt.

6. An electric food slicer as claimed in claim 3 wherein said bolt is comprised in said base portion.

7. An electric food slicer as claimed in claim 4 wherein said engaging means defining said recess is comprised in said operating portion.

8. An electric food slicer as claimed in claim 1 further comprising a handle.

9. An electric food slicer as claimed in claim 1 wherein said base portion and said operating portion are pivotably connected together.

10. An electric food slicer as claimed in claim 1 wherein said plastics or polymeric materials are selected from a group comprising acrylonitrile butadiene styrene (ABS), polypropylene (PP) and polycarbonate (PC).
